(19) United States
(12) Patent Application Publication
(10) Pub. No.: US 2026/0318266 A1
(43) Pub. Date: Oct. 15, 2026

(54) A GASIFICATION CHAMBER FOR A SOLID PROPELLANT CHARGE

(71) Applicant: TOVARYSTVO Z OBMEZHENOIU VIDPOVIDALNISTIU "ZAARBIRD", Kyiv (UA)

(72) Inventor: Vitalii Volodymyrovych YEMETS, Dnipro (UA)

(73) Assignee: TOVARYSTVO Z OBMEZHENOIU VIDPOVIDALNISTIU "ZAARBIRD", Kyiv (UA)

(21) Appl. No.: 19/114,644

(22) PCT Filed: Sep. 22, 2023
(86) PCT No.: PCT/UA2023/000046

§ 371 Date: Mar. 24, 2025

(30) Foreign Application Priority Data
Sep. 22, 2022 (UA) A202203519

(51) Int. Cl. F02K 9/12; B64G 1/40

(52) U.S. Cl. CPC F02K 9/12; B64G 1/403

(57) ABSTRACT

A gasification chamber of a rocket engine for a solid propellant charge, the charge consists of a shell that is made of a solid polymeric propellant and a solid oxidizer that is arranged within a volume. An inner surface of the chamber is in a contact with a divided propellant charge and is equipped with injectors for the propellant and injectors for the oxidizer which are mounted in zones of contact with the propellant and the oxidizer respectively, and channels which combine flows of uniform components of the propellant charge. The gasification chamber is further equipped with a divider of the solid polymeric propellant and the solid oxidizer, the divider is arranged at an input of the gasification chamber and is made as a cylindrical shell, the shell has one pointed end face that is arranged between the solid polymeric propellant and the solid oxidizer of the divided propellant charge and another end face that rests on the inner surface of the gasification chamber.

### FIELD OF THE INVENTION

The claimed invention relates to rocket and space equipment and it may be used for small rocket pods in order to inject small satellites into near-earth orbit or for small satellites in order to perform orbital maneuvers or braking when aborting from the orbit.

### PRIOR ART

It is known that small solid propellant engines have been proposed for operation of aerial vehicles [1], while in order to reduce a weight of such engines, as well as to align and stabilize burning of the propellant, it has been proposed to supply a divided coaxial propellant assembly (charge) to a gasifier that is equipped with injectors, and the propellant assembly is an external hollow cylinder that is made of fuel, e.g., a polymer, and a monolithic internal cylinder that is made of an oxidizer, e.g., lithium perchlorate.

The prior art teaches a gasification chamber [2] that is provided with channels to improve heating thereof. Such chamber utilizes a propellant charge that consists of a solid propellant (a shell) and an oxidizer that is arranged in the shell. Upon contact with a hot wall of the gasification chamber, a part of the propellant charge converts into gases. Then, gaseous components of the propellant pass along channels which are formed by grooves on the gasification chamber and on a cap to a combustion chamber adjacent to its head portion. In this place, the gases are mixed and burnt. However, this design does not avoid an explosion hazard of the hot mixture of the oxidizer and the fuel in the gasification chamber.

The closest prior art of the claimed solution is a gasifier of a solid-propellant rocket engine with feeding of a divided propellant charge to a combustion chamber [3], the gasifier is mounted between propellant gasification and combustion zones, as well as it is formed as a rotation body having a cone-shaped recess along an axis, that contacts with the propellant charge and equipped with injectors to discharge gasified components into the combustion chamber, where injectors for the propellant are mounted in a zone of contact between the propellant and the gasifier, while injectors for the oxidizer are mounted in a zone of contact between the oxidizer and the gasifier. A significant drawback of feeding of the divided propellant charge to the shared gasifier (gasification chamber) is an explosion hazard of the hot mixture of the oxidizer and the propellant in the gasification chamber, thus, its explosiveness.

Therefore, it is necessary to increase of usage safety and reliability of the solid-propellant engine with feeding of a divided propellant charge. The claimed invention aims at possibilities of dividing propellant components in the gasification chamber which will avoid their mixing and, thus, will eliminate a cause of explosion.

### SUMMARY OF THE INVENTION

The claimed invention relates to a gasification chamber for a solid propellant charge, the charge consists of a shell made of a solid polymeric propellant and a solid oxidizer that is arranged within a volume formed by the shell of said propellant, the chamber is formed as a rotation body having a cone-shaped recess along an axis, an inner surface of the chamber is in a contact with a divided propellant charge, and it is equipped with injectors for the propellant and injectors for the oxidizer which are mounted in zones of contact with the propellant and the oxidizer respectively, with channels which combine flows of uniform components of the propellant charge. The gasification chamber is further equipped with a divider of the solid polymeric propellant and the solid oxidizer, the divider is arranged at an input of the gasification chamber and is made as a cylindrical shell, the shell has one pointed end face that is arranged between the solid polymeric propellant and the solid oxidizer of the divided propellant charge and another end face that rests on the inner surface of the gasification chamber.

Details of one or more embodiments are provided in the appended drawings and in the description provided hereinafter. Other features, subjects and advantages will become apparent from the description and the drawings, as well as from claims.

### BRIEF DESCRIPTION OF THE FIGURES

FIG. 1 schematically illustrates a cross section of the gasification chamber.

FIG. 2 illustrates a section taken along a line A-A of FIG. 1.

FIG. 3 illustrates a flow of gasified components of the propellant in the gasification chamber.

### DETAILED DESCRIPTION OF THE INVENTION

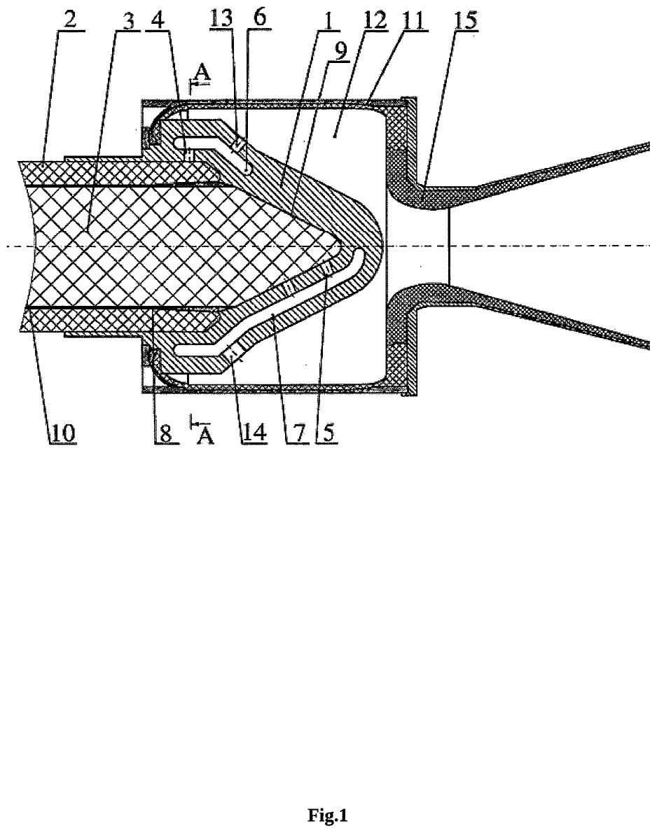

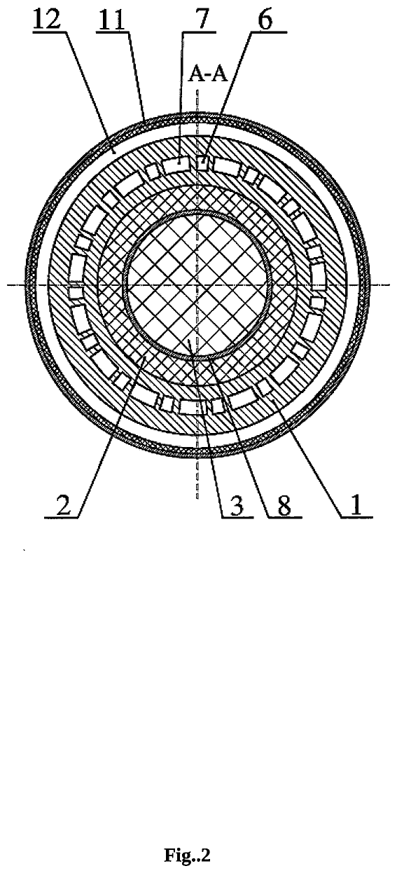

FIG. 1-2 illustrate a gasification chamber 1 for a solid propellant charge, the charge consists of a shell 2 that is made of a solid polymeric propellant and a solid oxidizer 3 that is arranged within a volume formed by the shell of said propellant. The gasification chamber 1 is formed as a rotation body having a cone-shaped recess along an axis, while an inner surface of the chamber is in a contact with the propellant charge that may be made as a hollow cylinder that is the shell 2 that is made of the solid polymeric propellant and a monolithic inner cylinder that is the solid oxidizer 3 that is arranged within the shell 2.

Low-melting polymers, e.g., polyethylene, polyformaldehyde and other, may be used as the propellant (the shell 2), while easily decomposing oxygen-containing compounds, e.g., lithium perchlorate, ammonium perchlorate, sodium nitrate and other, may be selected as the solid oxidizer 3. Selection of materials of the shell 2 and the oxidizer 3 is defined by energy requirements of the propellant charge, i.e., by a determined pulse per second of the propellant and hardness characteristics of the propellant charge and operation safety.

According to embodiments of the device, as it is illustrated in the section of FIG. 2 in the best way, cross-section areas of the hollow cylinder (the shell 2) and the monolithic cylinder (the oxidizer 3) must correspond to a ratio which is close to a stoichiometric ratio of the selected pair of components. For example, for the pair of low-pressure polyethylene-sodium nitrate, the cross-section area of the shell is 24.3% of the oxidizer area. Specific geometric characteristics of the coaxial propellant charge are defined by required traction characteristics of the claimed technical solution.

The gasification chamber 1 is equipped with injectors 4 for the propellant and injectors 5 for the oxidizer which are arranged in zones of contact with the propellant and the oxidizer respectively. Also, the gasification chamber 1 is provided with channels which are arranged at generator lines within the chamber, i.e., a channel 6 for the propellant, a channel 7 for the oxidizer which combine the gasified flows of uniform components of the propellant charge.

The gasification chamber 1 is further equipped with a divider 8 of the solid polymeric propellant 2 and the solid oxidizer 3, the divider is arranged at an input of the gasification chamber 1 and is made as a cylindrical shell, the shell has one pointed end face that is arranged between the solid polymeric propellant 2 and the solid oxidizer 3 of the divided propellant charge and another end face that rests on an inner surface 9 of the gasification chamber 1.

The divider of the solid polymeric propellant and the solid oxidizer mechanically divides the propellant and the oxidizer when they are in contact with the divider and creates separated oxidizer and propellant volumes in the gasification chamber, thereby avoiding mixing of the gasified components of the solid propellant charge. According to one of the preferred embodiments, the divider made of a heat-resistant steel is used.

According to various embodiments of the invention, a gap 10 may be provided between them depending on thermal-physical properties of the components of the propellant charge. Also, the gap 10 may be filled with a low thermal conductivity polymer, e.g., a fluoropolymer.

The propellant charge is fed to the gasification chamber 1 by any known method, e.g., by an electromechanical device (not shown), thereby enabling to control a feeding rate of the propellant charge for combustion.

Based on the provided FIG. 1-3, one of examples of operation of the rocket engine having the claimed gasification chamber is described herein below.

The gasification chamber 1 that is mounted within a housing 11 of an engine is heated up to a temperature (e.g., up to 800 ° C.) that is necessary for decomposition of the propellant 2 and the oxidizer 3 by means of, e.g., a starting propellant (not shown) which may be represented by a slow-burning pyrotechnic composition.

Then, a feeding device, e.g., the electromechanical device (not shown) feeds the propellant charge to the gasification chamber 1 in course of gasification of the propellant charge components 2 and 3.

Therewith, owing to the divider 8, the solid polymeric propellant 2 and the solid oxidizer 3 reach gasification sites on the inner surface of the gasification chamber separately. One end of the divider 8 enters the gap 10 between the propellant and the oxidizer, if it is present, or divides the propellant and the oxidizer mechanically (if there is no gap), while another end thereof rests on a base of the inner cone-shape surface 9 of the gasification chamber 1.

Then, the gasified propellant and oxidizer, via the injectors 4 for the propellant and the injectors 5 for the oxidizer, are fed to the channels 6 for the propellant and to the channels 7 for the oxidizer which are arranged at the generator lines within the gasification chamber.

The gasified components are fed to a combustion chamber 12 through propellant feeding openings 13 and oxidizer feeding openings 14, where they are mixed and combusted, thereby generating an excessive pressure in the combustion chamber, and drained out through a nozzle 15, while performing the required work.

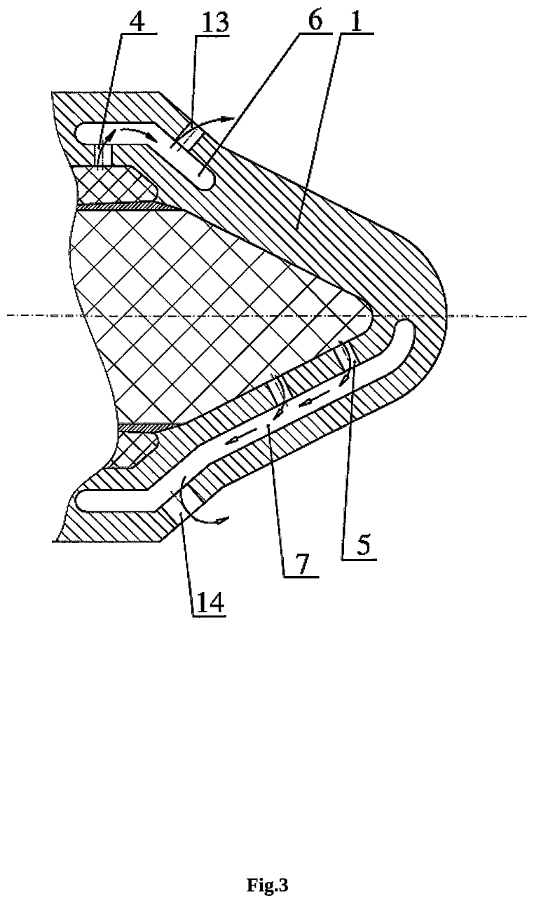

In FIG. 3, arrows indicate a flow of the gasification propellant in the injectors 4 for the propellant, the channels 6 for the propellant and the propellant feeding openings 13 to the combustion chamber, as well as arrows indicate a flow of the gasified oxidizer in the injectors 5 for the oxidizer, the channels 7 for the oxidizer and the oxidizer feeding openings 14 to the combustion chamber 12.

Although it is possible to perform various modifications and alternative embodiments of the invention, specific embodiments have been shown as exemplary in the drawings and described herein in detail. However, it shall be appreciated that the invention is not limited by specific disclosed embodiments. Instead, the invention includes all modifications, equivalents and alternatives which correspond to the essence and scope of the invention as defied in the appended claims provided hereinafter.

### LIST OF POSITIONS PROVIDED IN THE DESCRIPTION

1—the gasification chamber;
2—the shell made of the solid polymeric propellant;
3—the solid oxidizer;
4—the injector for the gasified polymeric propellant;
5—the injector for the gasified oxidizer;
6—the channel for the gasified polymeric propellant;
7—the channel for the gasified oxidizer;
8—the divider;
9—the inner surface of the gasification chamber;
10—the gap between the propellant and the oxidizer;
11—the engine housing;
12—the combustion chamber;
13—the gasified polymeric propellant feeding opening for feeding it to the combustion chamber;
14—the gasified oxidizer feeding opening for feeding it to the combustion chamber;
15—the nozzle.

Sources of Information:
1. “Optimization of a structure of solid-propellant rocket engines having metal housings by combining them to provide a monolithic compartment made of a high-impact plastic” “Space science and technology”, 2019, No. 6.
2. V. Yemets et al., Journal of the British Interplanetary Society, 2015.
3. Patent of Ukraine UA 124387 C2 “Solid propellant rocket engine”, 2021.

1. What is claimed is a gasification chamber for a solid propellant charge, the charge consists of a shell made of a solid polymeric propellant and a solid oxidizer that is arranged within a volume formed by the shell of said propellant, the chamber is formed as a rotation body having a cone-shaped recess along an axis, and an inner surface of the chamber is in a contact with a divided propellant charge, and it is equipped with injectors for the propellant and injectors for the oxidizer which are mounted in zones of contact with the propellant and the oxidizer respectively, and channels which combine flows of uniform components of the propellant charge, wherein it is further equipped with a divider of the solid polymeric propellant and the solid oxidizer, the divider is arranged at an input of the gasification chamber and is made as a cylindrical shell, the shell has one pointed end face that is arranged between the solid polymeric propellant and the solid oxidizer of the divided propellant charge and another end face that rests on the inner surface of the gasification chamber.
